(19) United States
(12) Patent Application Publication
(10) Pub. No.: US 2016/0347398 A1
(43) Pub. Date: Dec. 1, 2016

(54) Folding Handlebar

(71) Applicant: LEKUMA TECHNOLOGY INC., Taichung City (TW)

(72) Inventors: Yao-Chin Wang, Taichung City (TW); Jung-Yin LIN, Taichung City (TW)

(21) Appl. No.: 15/054,191

(22) Filed: Feb. 26, 2016

(30) Foreign Application Priority Data
May 26, 2015 (TW) 104116890

(51) Int. Cl. B62K 21/12

(52) U.S. Cl. CPC B62K 21/12

(57) ABSTRACT

A folding handlebar includes a stem, a pair of handles pivotally connected the stem, an abutting member, and a clamping device. The stem includes a fixing portion having a first abutting face, and an extending portion having a receiving space interconnected to a first bore. Each handle includes first and second joint faces. The abutting member includes a second abutting face abuttable against the first abutting face and one of the first and second joint faces, and a second bore aligned with the first bore. The clamping device includes a rod assembly inserted into the first and second bores, a fastener received into the receiving space and engageable with the rod assembly, and an eccentric member abuttable against the abutting member to selectively abut against the stem for providing a reliable engagement between the abutting member and the stem.

### BACKGROUND

The present invention relates to a handlebar and, more particularly, to a folding handlebar, which can be used in a folding vehicle.

Taiwan Utility Patent No. M270112 discloses a foldable handlebar (10), which comprises a base (20), first and second grasp rods (30 and 40) respectively pivotally connected to the base (20) to be capable of pivoting with respect to the base (20) between a folded position and a usage position, and fixed means for positioning the first and second grasp rods (30 and 40) in the folded position or the usage position. The base (20) is provided with a plurality of concave holes (244 and 264), and the first and second grasp rods (30 and 40) respectively includes a plurality of convex portions (344 and 444) that can engage into the concave holes (244 and 264) such that the first and second grasp rods (30 and 40) are positioned in the folded position or the usage position, respectively.

However, the engagement between the concave holes (244 and 264) and the convex portions (344 and 444) is poor in structural strength. Further, the concave holes (244 and 264) and the convex portions (344 and 444) are easy to be deformed to cause that the first and second grasp rods (30 and 40) can not to be positioned in the folded position or the usage position when the handlebar is suffered an accidental impact.

Thus, a need exists for a novel folding handlebar to mitigate and/or obviate the above disadvantages.

### BRIEF SUMMARY

This need and other problems in the field of folding handlebars are solved by a folding handlebar including a stem, a pair of handles pivotally connected the stem, an abutting member, and a clamping device. The stem includes a fixing portion and an extending portion connected with each other. The fixing portion has a first abutting face opposite to the extending portion, and the extending portion has a receiving space interconnected to a first bore extending through the first abutting face. Each handle includes first and second joint faces. The abutting member includes a second abutting face abuttable against the first abutting face and one of the first and second joint faces, and a second bore extending therethrough and aligned with the first bore. The clamping device includes a rod assembly inserted into the first and second bores, a fastener received into the receiving space and engageable with the rod assembly, and an eccentric member abuttable against the abutting member to selectively abut against the stem for providing a reliable engagement between the abutting member and the stem.

Illustrative embodiments will become clearer in light of the following detailed description described in connection with the drawings.

### DESCRIPTION OF THE DRAWINGS

The illustrative embodiments may best be described by reference to the accompanying drawings where:

FIG. 1 is a perspective view of a folding handlebar according to the present invention in a usage position.

FIG. 2 is an exploded, perspective view of the folding handlebar of FIG. 1.

FIG. 3 is a cross sectional view of the folding handlebar of FIG. 1.

FIG. 4 is another cross sectional view of the folding handlebar of FIG. 1.

FIG. 5 is a continued view of the folding handlebar of FIG. 3, and illustrates an eccentric member pivoted in a direction indicated by an arrow.

FIG. 6 is a continued view of the folding handlebar of FIG. 5, and illustrates a pair of handles pivoted in their respective direction indicated by arrows.

FIG. 7 is a continued view of the folding handlebar of FIG. 6, and illustrates the folding handlebar folded from the usage position to a folded position.

FIG. 8 is a perspective view of the folding handlebar according to the present invention in the folded position.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “third”, “fourth”, “bottom”, “side”, “end”, “portion”, “section”, “spacing”, “length”, “depth”, “thickness”, and similar terms are used herein, it should be understood that these terms have reference only to the structure shown in the drawings as it would appear to a person viewing the drawings and are utilized only to facilitate describing the illustrative embodiments.

### DETAILED DESCRIPTION

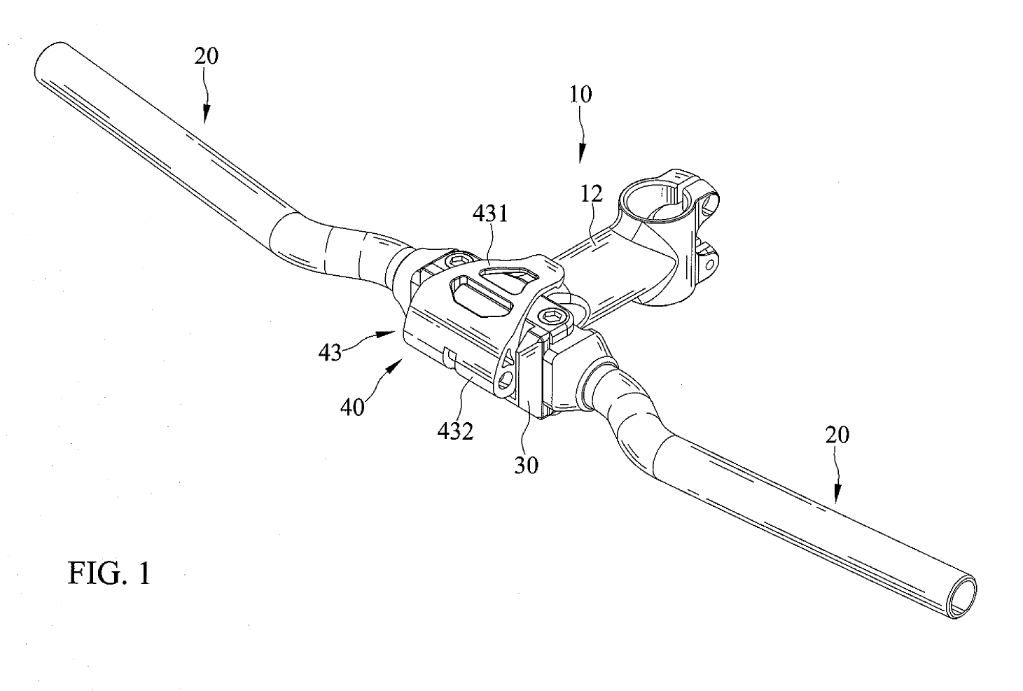

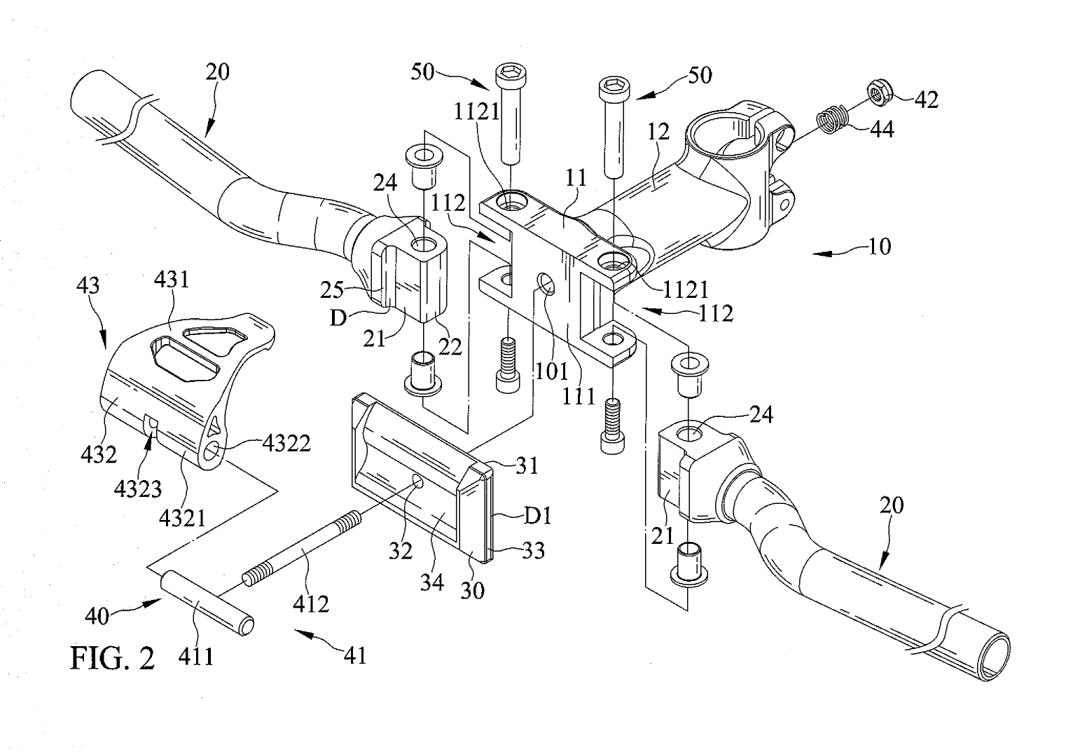

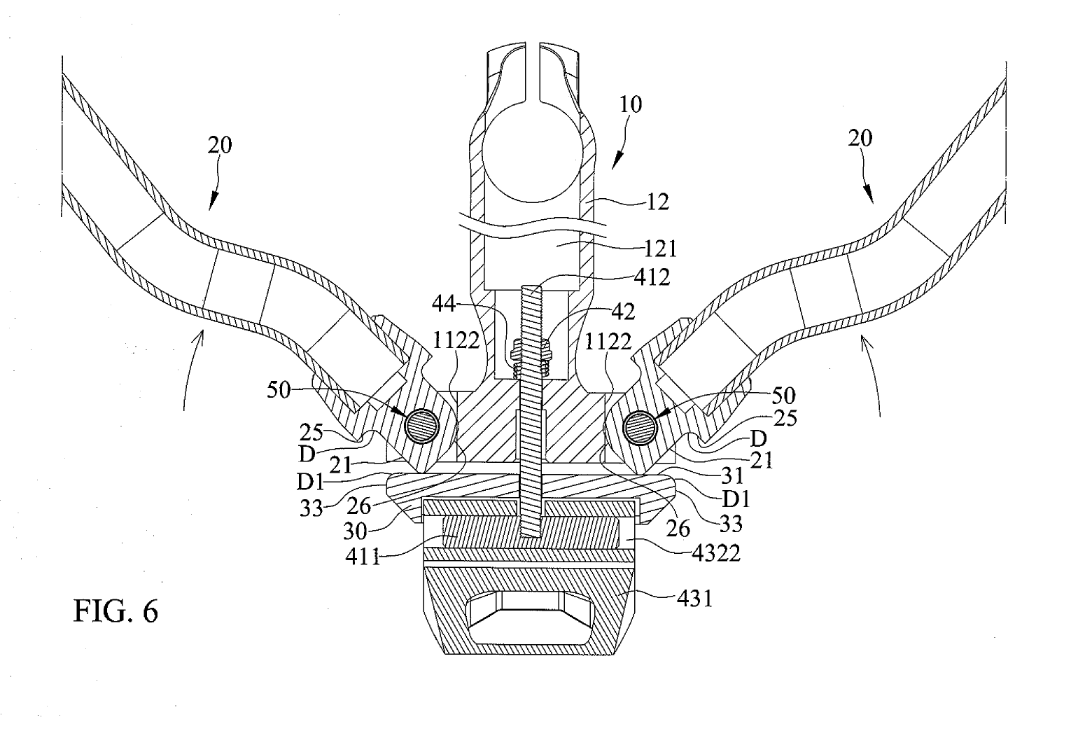

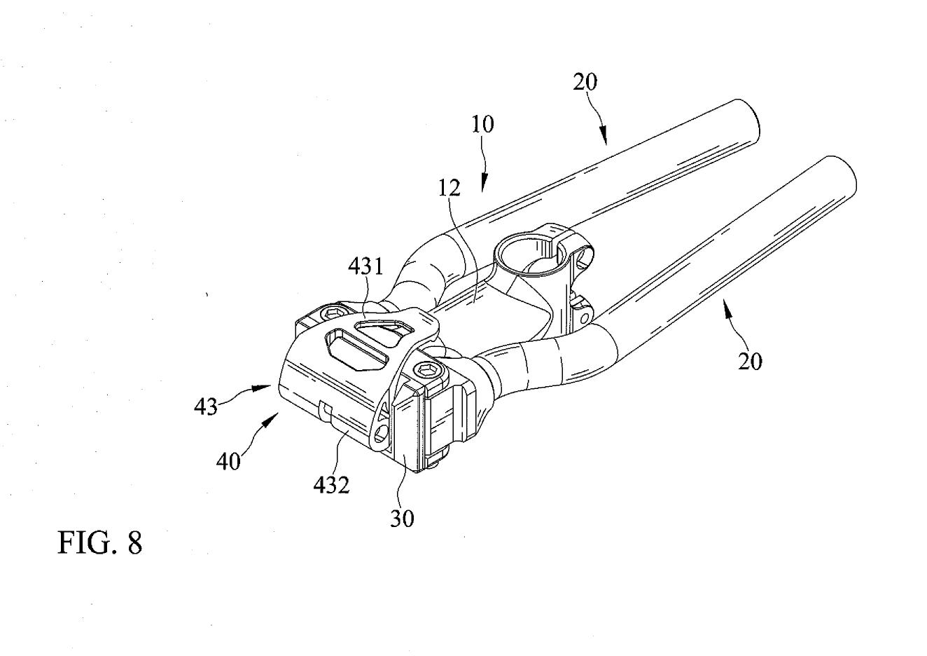

FIGS. 1-8 show a folding handlebar according to the present invention. The folding handlebar includes a stem 10 adapted to mounted on a fork of a folding vehicle, a pair of handles 20 pivotally connected two opposite ends of the stem 10, an abutting member 30 adapted to abut against the stem 10 and the pair of handles 20, and a clamping device 40 extending through the stem 10 and the abutting member 30 for selectively clamping the stem 10, the pair of handles 20 and abutting member 30. The folding handlebar can be operated between a usage position and a folded position, so that the folding handlebar applied to the folding vehicle can be convenient to carry out and also does not occupy the space.

The stem 10 including a fixing portion 11 and an extending portion 12 connected with each other. The fixing portion 11 has a first abutting face 111 opposite to the extending portion 12. The extending portion 12 has a receiving space 121 interconnected to a first bore 101 extending through the first abutting face 111. In the embodiment, the first abutting face 111 is substantially an H-shaped plane. The fixing portion 11 including two recesses 112 arranged at two opposite ends thereof. Each recess 112 has a first through-hole 1121 extending therethrough, and a bottom surface 1122 perpendicular to the first abutting face 111 of the stem 10.

Each handle 20 includes first, second, and third joint faces 21, 22, and 23. The first abutting face 111 and one of the first and second joint faces 21 and 22 is located in the same plane when the folding handlebar is in the usage position or the folded position. The third joint face 23 is arranged between the first and second joint faces 21 and 22.

Further, each handle 20 is pivotally engaged with each respective recess 112 and has a second through-hole 24 extending therethrough and aligned with the first through-hole 1121. Two pin 50 each are inserted into the respective first and second through-holes 1121 and 24. In the embodiment, the first, second, and third joint faces 21, 22, and 23 are substantially flat and respectively parallel to the second through-hole 24.

Furthermore, each handle 20 includes a stop protrusion 25 arranged adjacent to the first joint face 21 and having a stop face connected with a side of the first joint face 21 opposite to the second joint face 22. An included angle of less than 90 degrees is formed between the stop face and the first joint face 21. A first arc face D is disposed between the stop face and the first joint face 21. In the embodiment, the stop face of the stop protrusion 25 is substantially flat and respectively parallel to the second through-hole 24. A fillet 26 is formed between the second and third joint faces 22 and 23 to facilitate a smooth pivotment between the stem 10 and the pair of handles 20. The bottom surface 1122 is abuttable against one of the second and third joint faces 22 and 23 and the fillet 26 when the folding handlebar is operated between the usage position and the folded position.

The abutting member 30 includes a second abutting face 31 abuttable against the first abutting face 111 and one of the first and second joint faces 21 and 22 for providing a reliable engagement, and a second bore 32 extending therethrough and aligned with the first bore 101. In the embodiment, the second abutting face 31 is substantially a rectangular plane. The abutting member 30 further includes a stop wall 33 disposed therearound and abuttable against the respective stop protrusion 25, and a concave arc face 34 at one side thereof opposite to the second abutting face 31. A second arc face D1 is disposed between the second abutting face 31 and the stop wall 33, and corresponds to and abuttable against the first arc face D.

The clamping device 40 includes a rod assembly 41 inserted into the first and second bores 101 and 32, a fastener 42 received into the receiving space 121 and engageable with the rod assembly 41, an eccentric member 43 abuttable against the abutting member 30, and a biasing member 44 received into the receiving space 121 and detachably mounted to the rod assembly 41. The rod assembly 41 includes a first rod member 411 and a second rod member 412 detachably connected with each other. In the embodiment, the fastener 42 is hexagon nut. The eccentric member 43 includes a lever section 431 adapted to be operated by a user, and an eccentric section 432 disposed opposite to the lever section 431. The eccentric section 432 extends along a central axis A and is pivotally connected to the rod assembly 41 to be abuttable against the concave arc face 34 of the abutting member 30. Further, the eccentric section 432 includes an arc face 4321 opposite to the lever section 431, and an orifice 4322 extending along an eccentric axis B spaces from the central axis A. A distance C is formed between the central and eccentric axes A and B. The eccentric section 432 further includes a gap 4323 interconnected with the orifice 4322. The second rod member 412 is located within the gap 4323 and is inserted through the first and second bores 101 and 32. The second rod member 412 has a first end and a second end spaced from each other. The first end is threadedly connected to and arranged perpendicular to the first rod member 411, and the second end is threadedly connected to the fastener 42. The biasing member 44 is received into the receiving space 121 and is mounted around the second rod member 412 to be disposed between and connects to an inner wall of the receiving space 121 and the fastener 42.

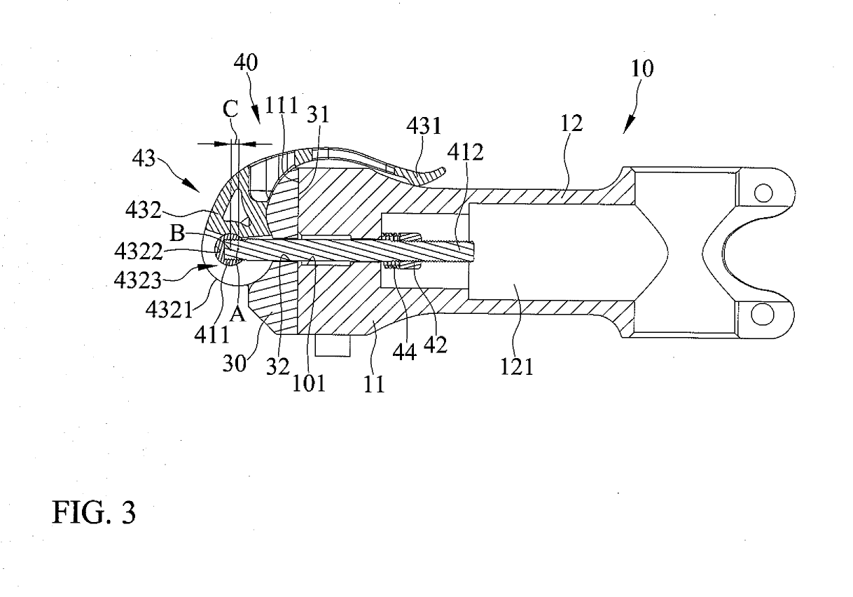

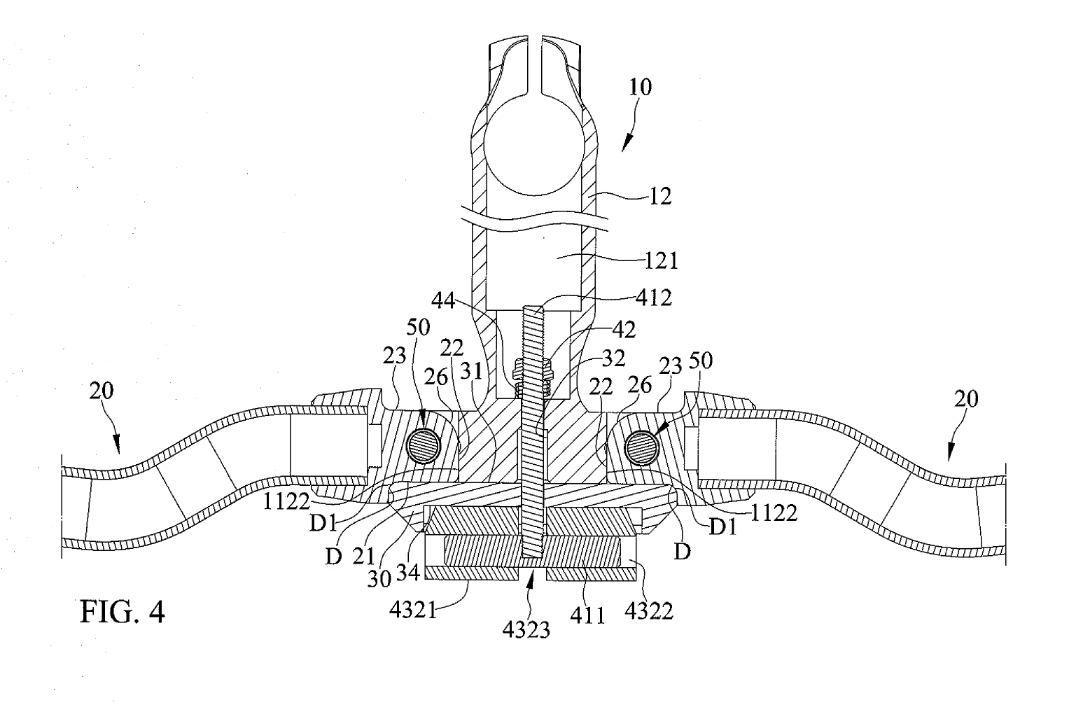

When the folding handlebar is located in the usage position (shown in FIGS. 3 and 4), the first abutting face 111 and the first joint faces 21 of the pair of handles 20 is located in the same plane. Moreover, the second abutting face 31 abuts against the first abutting face 111 and the first joint faces 21 of the pair of handles 20 for providing a reliable and stronger engagement to suffer an accidental impact. The stop wall 33 abuts against the respective stop protrusion 25 of the pair of handles 20.

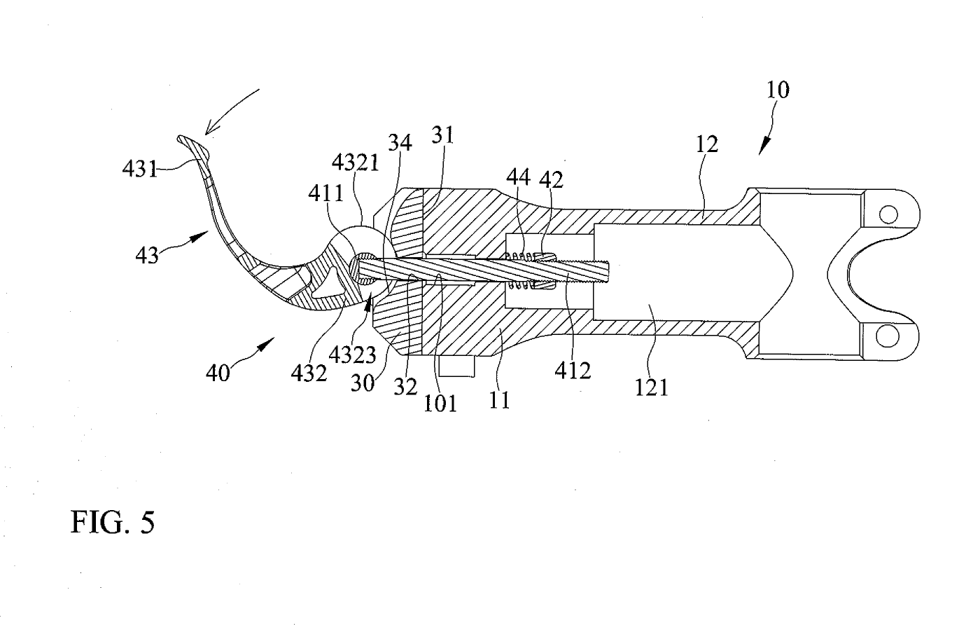

When the folding handlebar is folded from the usage position to the folded position (shown in FIGS. 5, 6, and 7), a user can turn the lever section 431 of the eccentric member 43 to cause the arc face 4321 spaced from the concave arc face 34 of the abutting member 30. Thus, the biasing member 44 biasing against the stem 10 and the fastener 42 causes that the second abutting face 31 spaces from the first abutting face 111 and the first joint faces 21 of the pair of handles 20 to permit the pair of handles 20 pivotable in relation to the stem 10. Pivoting the pair of handles 20 compresses the biasing member 44 and causes that the third joint faces 23 of the pair of handles 20 abuts against the bottom surface 1122. Then, the user can turn the lever section 431 of the eccentric member 43 again to cause the arc face 4321 abutting against the concave arc face 34 of the abutting member 30. The abutting member 30 slides through the second rod member 412 under a restoring force of the biasing member 44 to cause the second abutting face 31 abuts against the second joint faces 22 of the pair of handles 20 to helps the user fold it fast.

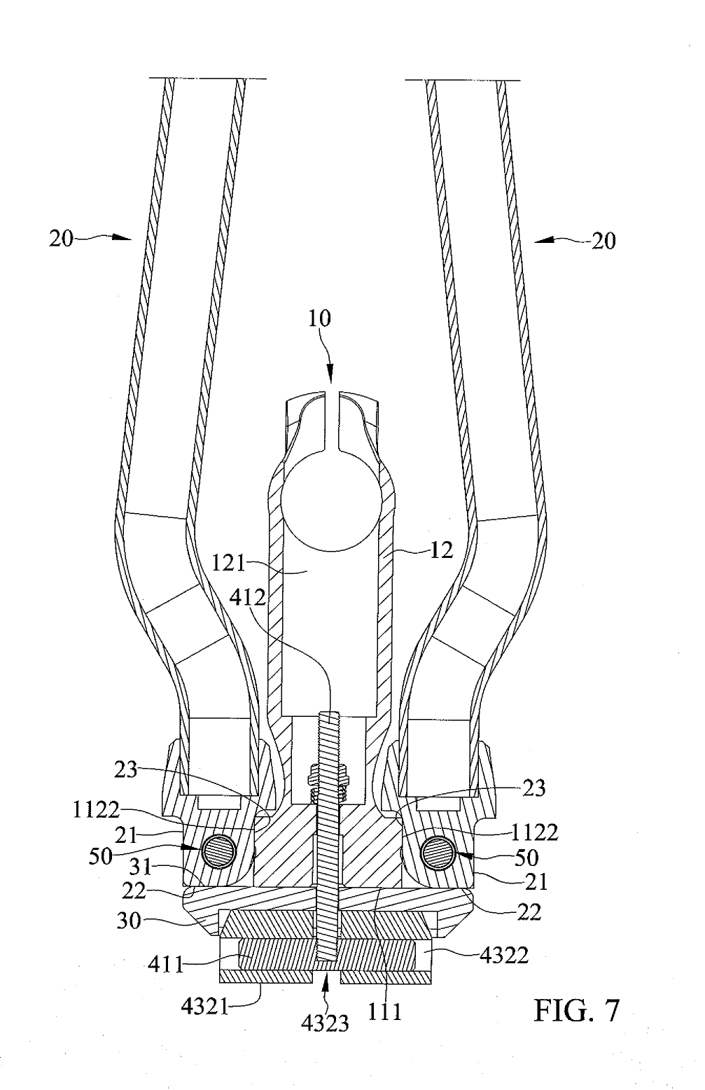

When the folding handlebar is located in the folded position (shown in FIG. 7), the first abutting face 111 and the second joint faces 22 of the pair of handles 20 is located in the same plane. Moreover, the second abutting face 31 abuts against the first abutting face 111 and the second joint faces 22 of the pair of handles 20 for providing a reliable and stronger engagement to suffer an accidental impact.

Thus since the illustrative embodiment disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A folding handlebar operated between a usage position and a folded position comprising:
a stem including a fixing portion and an extending portion connected with each other, with the fixing portion having a first abutting face opposite to the extending portion, with the extending portion having a receiving space interconnected to a first bore extending through the first abutting face;
a pair of handles pivotally connected the stem, with each handle including first and second joint faces;
an abutting member including a second abutting face abuttable against the first abutting face and one of the first and second joint faces, and a second bore extending therethrough and aligned with the first bore; and
a clamping device including a rod assembly inserted into the first and second bores, a fastener received into the receiving space and engageable with the rod assembly, and an eccentric member abuttable against the abutting member;
wherein when the folding handlebar is located in the usage position, the second abutting face abuts against the first abutting face and the first joint faces of the pair of handles;
wherein when the folding handlebar is located in the folded position, the second abutting face abuts against the first abutting face and the second joint faces of the pair of handles.

2. The folding handlebar as claimed in claim 1, with the fixing portion including two recesses arranged at two opposite ends thereof, with each recess having a first through-hole extending therethrough, with each handle pivotally engaged with each respective recess and having a second through-hole extending therethrough and aligned with the first through-hole, and with two pin each inserted into the respective first and second through-holes.

3. The folding handlebar as claimed in claim 2, with each handle including a stop protrusion arranged adjacent to the first joint face, and with the abutting member including a stop wall disposed therearound and abuttable against the respective stop protrusion.

4. The folding handlebar as claimed in claim 3, with each handle further including a third joint face arranged between the first and second joint faces, with a fillet formed between the second and third joint faces, and with each recess including a bottom surface perpendicular to the abutting face of the stem and abuttable against one of the second and third joint faces and the fillet.

5. The folding handlebar as claimed in claim 3, with the stop protrusion having a stop face connected with a side of the first joint face opposite to the second joint face, and with an included angle of less than 90 degrees formed between the stop face and the first joint face.

6. The folding handlebar as claimed in claim 5, with the first abutting face being substantially a H-shaped plane, with the first, second, third joint faces, and the stop face of the stop protrusion being substantially flat and respectively parallel to the second through-hole, with the second abutting face being substantially a rectangular plane, and with the first abutting face and one of the of the first and second joint faces located in the same plane.

7. The folding handlebar as claimed in claim 1, with the abutting member including a concave arc face at one side thereof opposite to the second abutting face, with the eccentric member including a lever section and an eccentric section disposed opposite to the lever section, and with the eccentric section pivotally connected to the rod assembly and abuttable against the concave arc face of the abutting member.

8. The folding handlebar as claimed in claim 7, with the eccentric section extending along a central axis, with the eccentric section including an arc face opposite to the lever section, and an orifice extending along an eccentric axis spaces from the central axis, with a distance formed between the central and eccentric axes, and with the rod assembly including a first rod member inserted into the orifice.

9. The folding handlebar as claimed in claim 8, with the eccentric section further including a gap interconnected with the orifice, with the rod assembly further including a second rod member located within the gap and inserted through the first and second bores, with the second rod member having a first end and a second end spaced from each other, with the first end threadedly connected to and arranged perpendicular to the first rod member, and with the second end threadedly connected to the fastener.

10. The folding handlebar as claimed in claim 9, with clamping device further including a biasing member received into the receiving space and mounted around the second rod member, and with the biasing member is disposed between and connects to an inner wall of the receiving space and the fastener.
